(19) United States
(12) Patent Application Publication
(10) Pub. No.: US 2023/0044683 A1
(43) Pub. Date: Feb. 9, 2023

(54) WIRELESS CAMERA HUB SYSTEM

(71) Applicant: GENTEX CORPORATION, Zeeland, MI (US)

(72) Inventors: Bradley A. Bosma, Hudsonville, MI (US); David M. Falb, Hudsonville, MI (US)

(73) Assignee: GENTEX CORPORATION, Zeeland, MI (US)

(21) Appl. No.: 17/881,971

(22) Filed: Aug. 5, 2022

Related U.S. Application Data
(60) Provisional application No. 63/230,133, filed on Aug. 6, 2021.

(51) Int. Cl. B60R 1/02; B60R 1/26

(52) U.S. Cl. CPC B60R 1/025; B60R 1/26; B60R 2300/8026; B60R 2300/103; B60R 2001/1253

(57) ABSTRACT

A system for capturing and displaying images may comprise a rearview assembly having WIFI capability; and a WIFI hub removably securable to a surface, the WIFI hub comprising at least one imager capable of capturing images of a scene. The WIFI hub may be capable of transmitting image data from the captured images to the rearview assembly. The rearview assembly may be capable of displaying images from the image data from the captured images.

### CROSS REFERENCE TO RELATED APPLICATIONS

This application claims the benefit of and priority to U.S. Provisional Patent Application No. 63/230,133, filed on Aug. 6, 2021, entitled “Wireless Camera Hub System,” the entire disclosure of which is hereby incorporated herein by reference.

### FIELD OF THE DISCLOSURE

This disclosure relates generally to systems for capturing and displaying images and, in particular, to systems for capturing images and displaying the captured images on a rearview assembly of a vehicle.

### BACKGROUND

When vehicles are pulling trailers, the driver of the vehicle may not be able to use the rearview mirror to see behind them as the trailer may block the view. Spotter or blind spot mirrors on the side of the vehicle may help to alleviate the situation, but their fields of view may be limited. Additionally, there may be a need to capture images in a different field of view for display.

### SUMMARY

A system for capturing and displaying images may comprise a rearview assembly having a display element and WIFI capability and a WIFI hub removably securable to a surface, The WIFI hub may comprise at least one imager capable of capturing images of a scene. The WIFI hub may have the capability to transmit and receive signals via WIFI. The WIFI hub may be capable of transmitting image data from the captured images to the rearview assembly. The system may further comprise an image processor in communication with the rearview assembly, the image processor being capable of processing captured images. The rearview assembly may be capable of displaying images from the image data from the captured images.

The system may further comprise at least one second imager. The WIFI hub may be capable of transmitting and receiving image data from a plurality of imagers. The at least one second imager may be removably securable to a surface. At least one of the imagers may comprise an infrared light source and may be configured to capture images using infrared light.

The WIFI hub may be capable of communicating with external devices through signals transmitted through WIFI. The image processor may be in communication with the rearview assembly; and the rearview assembly may display the captured images on the display element. The system may further comprise a memory, and a subset of captured images may be stored in the memory.

The system may further comprise a user interface. The user interface may allow a user to cause the display of two different images on the display element of the rearview assembly. One of the displayed images comprises images captured by the one of the imager of the WIFI hub and the second imager. The user interface may allow a user to activate one or more of the at least one second imagers. The system may further comprise an application that is accessible through a mobile phone. A user may be able to view captured images and control aspects of the system on the mobile phone application. The system may be capable of connecting directly to a WIFI source. The system may be capable of wirelessly storing images on a remote server. At least one of the second imagers may be positioned to capture image data from inside the vehicle. The WIFI hub may comprise its own source of power.

### BRIEF DESCRIPTION OF THE DRAWINGS

FIG. 1A illustrates a schematic diagram of a WIFI-enabled full display rearview assembly for a vehicle in accordance with this disclosure;

FIG. 1B illustrates a perspective view of the rearview assembly of FIG. 1 disposed within a vehicle;

FIG. 1C illustrates a vehicle having full display rearview assembly in communication with an imager;

FIG. 2 illustrates a vehicle having full display rearview assembly in communication with an imager, and a WIFI hub in communication with the full display rearview assembly;

FIG. 3 illustrates a detail of the system illustrated in FIG. 4A;

FIG. 4 illustrates a system having a plurality of second imagers;

FIG. 5A illustrates a full display rearview assembly displaying an image captured by an imager;

FIG. 5B illustrates a full display rearview assembly displaying two different images captured by imager(s);

FIG. 5C illustrates a full display rearview assembly displaying two different images captured by imager(s);

FIG. 5D illustrates a full display rearview assembly displaying two different images captured by different imagers;

FIG. 6 illustrates a system having a plurality of imagers and a remote viewing capability;

FIG. 7 illustrates some example locations imagers that are part of the wireless hub system; and

FIG. 8 illustrates a full display rearview assembly displaying two different images captured by the imagers in FIG. 7.

### DETAILED DESCRIPTION

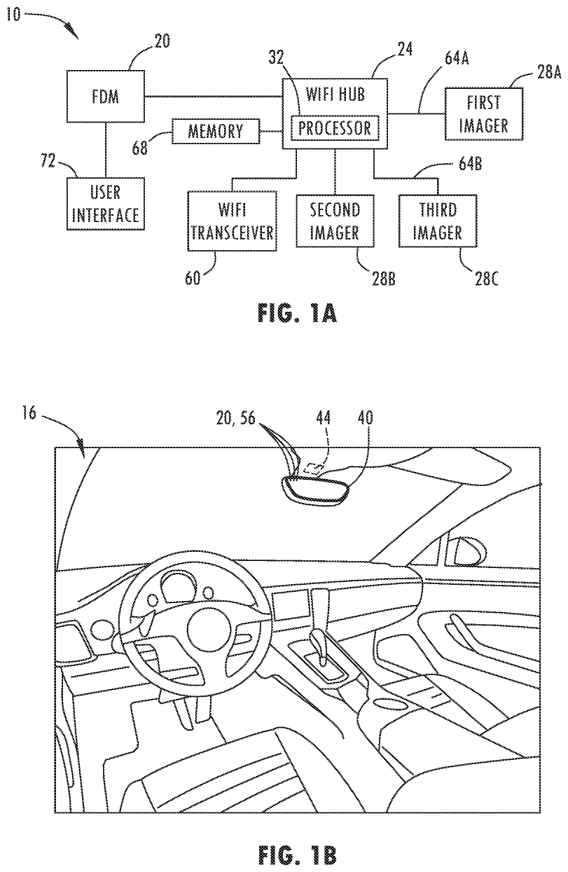

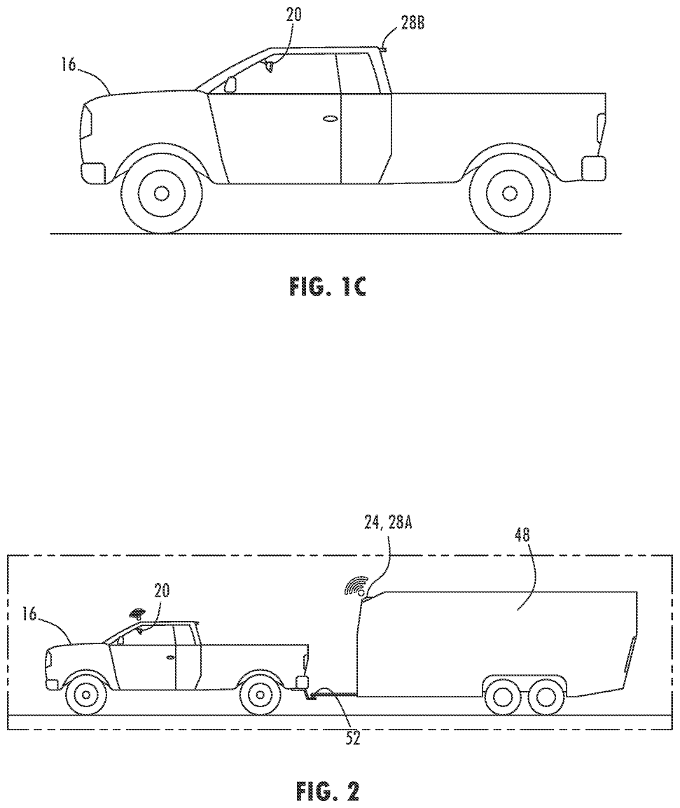

Referring to FIGS. 1A-2, a wireless hub system for capturing images of scenes in the vicinity of a vehicle 16 and transmitting image data from the captured images is generally indicated at 10. Wireless hub system 10 may include a full display rearview assembly 20 having a display element 56 and WIFI capabilities, a WIFI hub 24 having a first camera or imager 28A, and a processor 32. In some embodiments, wireless hub system 10 may further comprise at least one second camera or imager 28B.

Full display rearview assembly 20 may further comprise a WIFI transmitter and/or receiver or transceiver 60 and may be capable of communicating with other components of wireless hub system 10 or with external devices such as a mobile phone 80 through signals transmitted and received via WIFI.

WIFI hub 24 may be removably securable to a surface. In some embodiments, WIFI hub 24 may be capable of being secured to a first surface, removed, and later being secured to a second surface. WIFI hub 24 may comprise a receiver and a transmitter or a transceiver (not shown), thereby allowing WIFI hub 24 to transmit and receive signals via WIFI. WIFI hub 24 may be mounted on or in a vehicle 16 or on or in a trailer 48. As used herein, the term “trailer” refers to items being towed by vehicle 16 such as trailers, recreational vehicles, boats, semi-trailers, and the like.

First imager 28A may be powered by WIFI hub 24. First imager 28A may be configured to capture first images from a first field of view and transmit image data from the captured images to full display rearview assembly 20. First images may be selectively displayed on display element 56 of full display rearview assembly 20.

Wireless hub system 10 may further include at least one second imager 28B. Wireless hub system 10 may comprise one, two, three, four, five, six, seven, eight, or N second imagers 28B. The N second imagers 28B may all have wired connections to WIFI hub 24. Alternatively, the N second imagers 28B may be connected wirelessly to WIFI hub 24.

The at least one second imager 28B may be connected, either wired or wirelessly, to WIFI hub 24. The at least one second imager 28B may be disposed in a variety of places, such as an exterior surface or an interior surface or vehicle, an exterior surface of trailer 48, or in the interior of trailer 48. For example, as shown in FIG. 4C, first imager 28A may be disposed on rear of trailer 48, and may be configured to have a field of view including scenes to the rear of trailer 48. The at least one second imager 28B may be in wired or wireless communication with WIFI hub 24. In some embodiments, a wired connection 64A may extend between first imager 28A and WIFI hub 24.

Each of first and second imagers 28A, 28B may each include a lens (not shown) and an image sensor (not shown) such as a complementary metal-oxide-semiconductor (“CMOS”) that can create image data when activated. First imagers 28A may thus generate image data from first field of view. The at least one second imager 28B may be configured to capture second images from a second field of view. In some embodiments, a plurality of second imagers 28B may each be configured to capture images and each second imager 28B may each have its own field of view. The second field of view may comprise a scene to the exterior of the vehicle 16 and may be of a scene to the rear of the vehicle.

Each of the N second imagers 28B may further all be configured to have different fields of view and be capable of capturing scenes in and/or around vehicle 16 and/or trailer 48. The fields of view of each of the N second imagers 28B may overlap partially or completely with fields of view of other second imagers 28B, or they may be completely independent of the fields of other second imagers 28B. Each of the N second imagers 28B may be connected to a power source such as a trailer battery or other power source.

Some or all of the at least one second imagers 28B may be located remotely from WIFI hub 24. The at least one second imager 28B may be in communication with WIFI hub 24. The at least one second imager 28B may be connected to WIFI hub 24 via a wired connection 64B. Alternatively, the at least one second imager 28B may be connected to WIFI hub 24 wirelessly. WIFI hub 24 may receive image data from images captured by both first and second imagers 28A, 28B.

Images captured by at least one of first imager 28A and second imager 28B may be selectively displayed on full display rearview assembly 20. The images may be displayed on display element 56 of full display rearview assembly 20. Additionally, or alternatively, the images may be displayed on a display element such as a mobile phone screen (not shown).

First imager 28A and second imager 28B may be in communication with processor 32. The processor 32 may be a general or application specific processor or circuit for performing calculations, handling inputs, generating outputs, and may be configured to process image data received from first imager 28A and/or the at least one second imager 28B.

Processor 32 may be capable of receiving image data from first images captured by first imager 28A and from second images captured by the at least one second imager 28B. Processor 32 may be in communication with full display rearview assembly 20 and may be capable of transmitting image data to full display rearview assembly 20 to be displayed on display element 56 therein.

The communication between first imager 28A, second imager 28B and processor 32 may be wirelessly, through WIFI or other wireless protocols, or may be through wired means. Processor 32 may be configured to process image data from images captured by first imager 28A and second imager 28B.

Similar to WIFI hub 24, the at least one second imager 28B may be capable of being mounted on or in vehicle 16 or on or in a trailer 48. Second imager 28B may be in communication with full display rearview assembly 20 through WIFI hub 24. Images captured by second imager 28B may, upon the receipt of particular inputs, be displayed on display element 56 of full display rearview assembly 20.

The at least one second imager 28B may be oriented in a variety of ways to capture images of scenes at various locations about the vehicle 16. Each of the at least one second imagers 28B may be mounted in a variety of locations such as, but not limited to, a tail light(s) or a center high-mounted stop light (CHMSL) assembly, or provided as an integral component such as, but not limited to, behind a rear window as disclosed in U.S. Pat. No. 6,550,949 or inside a rearview assembly 20 as disclosed in U.S. Pat. No. 6,611,610, the entire disclosures of which are incorporated herein by reference.

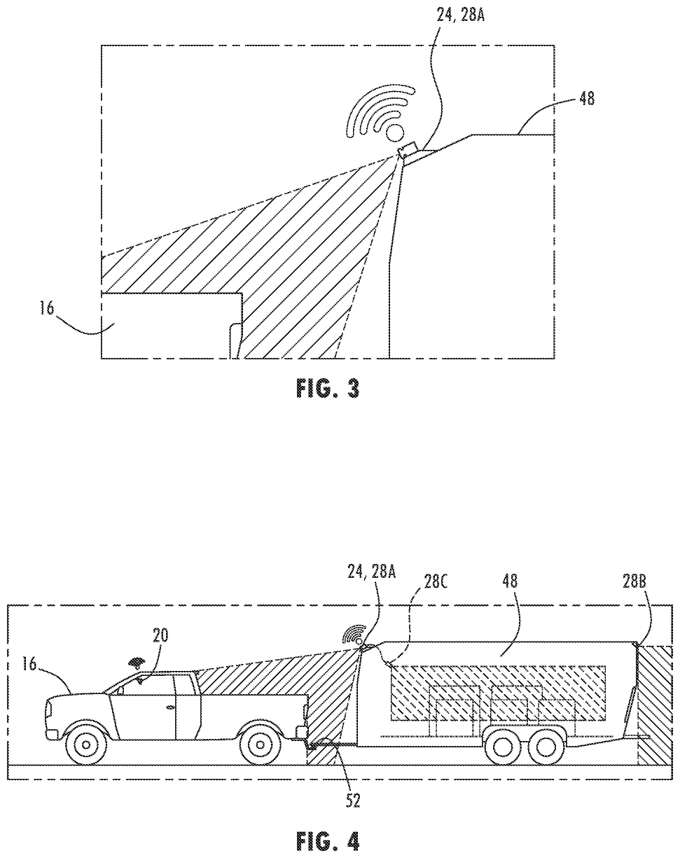

Referring now to FIG. 3, WIFI hub 24 may be removably securable to a surface such as an exterior surface or an interior surface of a trailer 48 being towed by vehicle 16. WIFI hub 24 may additionally, or alternatively be removably securable to other surfaces such as, for example, an interior or exterior surface of vehicle 16. In some embodiments, first imager 28A may be disposed so that the field of view of first imager 28A is behind the trailer 48 being towed. WIFI hub 24 may be paired with full display rearview assembly 20 and may be capable of communicating with full display rearview assembly 20 and with other WIFI-enabled components and accessories through WIFI. WIFI hub 24 may be further capable of transmitting image data from scenes captured by first imager 28A to full display rearview assembly 20 for display. Thus, a driver may be able to view the scene behind the trailer 48 from full display rearview assembly 20. This may be a more natural place from which to view the scene as it is where rearward views are generally displayed when driving a vehicle 16.

In some embodiments, at least one imager 28A, 28B may comprise an infrared light source (not shown). In some embodiments, light source may be manually activated, or may be activated upon the activation of the imager 28. In some embodiments, a light sensor (not shown) may be in communication with imager, and light source may be activated upon the receipt of a sensor input indicating that ambient light levels are below a predetermined threshold.

Full display rearview assembly 20 may include a housing 40 and a mount 44 for mounting housing 40 to the vehicle 16. Mount 44 may be of any conventional type and may be configured to attach full display rearview assembly 20 to a windshield, roof, headliner, or overhead console of vehicle 16.

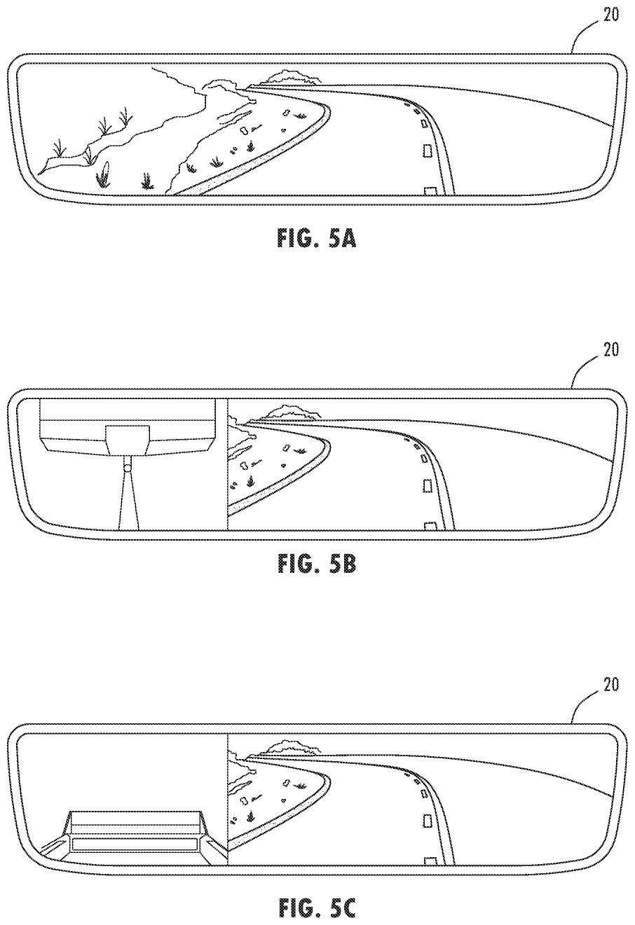

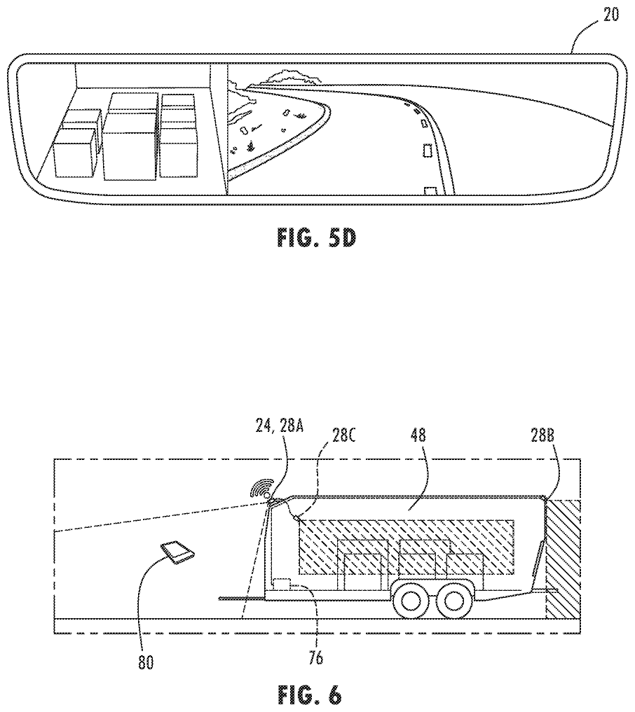

As shown in FIGS. 5A-5D, full display rearview assembly 20 may be configured to receive and display image data from scenes captured by first imager 28A and the at least one second imager 28B. In a vehicle 16 towing a trailer 48, it may be difficult or impossible to see what is behind the trailer 48 through a standard rearview mirror, as the trailer 48 may block the view. As shown in FIG. 5A, a second imager 28B disposed on the rear of the trailer 48 may capture images of the scene to the rear of trailer 48, and may transmit image data from the captured scenes to full display rearview assembly 20. Full display rearview assembly 20 may display the captured images, thus allowing a user to view the scene behind the trailer 48.

The at least one second imager 28B may be configured to capture a variety of different scenes. For example, as shown in FIG. 5B, a second imager 28B may be disposed to capture images of a trailer hitch 52, thereby allowing a user to confirm that the trailer is securely attached to trailer hitch 52 and that the trailer hitch 52 is free from obstructions.

Display element 56 may be supported by a housing 40. Display element 56 may be embodied as a liquid crystal display (LCD), a light emitting diode (LED) display, an organic LED (OLED) display, or other display suited for use in a full display rearview assembly 20.

Wireless hub system 10 may further comprise a memory 68. Memory 68 may be volatile and/or non-volatile memory. Memory 68 may be random access memory, read only memory, flash memory, hard disk storage, flash memory storage, solid state drive memory, etc. In some embodiments, processor 32 may read and write to memory 68. Memory 68 may be disposed in one of full display rearview assembly 20 and WIFI hub 24 and may be in communication with processor 32. Memory 68 may be configured to store captured image data for a period of time. In some embodiments, memory 68 may store image data for a certain predetermined time period, after which new image data may be stored in its place. This may be due to limitations of storage capacity. In some embodiments, memory 68 may store images only upon certain criteria being met such as the receipt of an input from a sensor such as a motion detector. The input may indicate, for example, that motion has been detected within trailer 48 or in proximity to a trailer 48 or trailer hitch 52. In some embodiments, memory 68 may store image data upon the receipt of a particular input from a user interface 72 or upon other criteria being met such as vehicle 16 being put into motion or being parked. Upon receipt of the input, at least one imager 28A, 28B may begin to capture images and memory 68 may store image data from the captured images. User may be able to selectively activate only a certain imager or imagers 28A, 28B and may be able to determine which imager or imagers 28A, 28B will be activated. The capture and storage of image data may continue until the occurrence of an event that causes the memory 68 to stop storing image data or that causes imagers 28A, 28B to stop capturing images. The event may be, for example, the passage of a predetermined amount of time, the passage of a predetermined time during which no further inputs are received, the receipt of a user input, and the like.

User interface 72 may be located remotely from one or more other components of wireless hub system 10. For example, user interface 72 may be disposed on a steering wheel, on a console, or on rearview assembly 20 of the vehicle User interface 72 may communicate via wire or wirelessly with the remaining components of wireless hub system 10. User interface 72 may be in communication with transceiver 60 for transmitting signals corresponding to received inputs and for receiving status or other information to be conveyed to a vehicle occupant. User interface 72 may be in communication with or disposed on full display rearview assembly 20. User interface 72 may allow a user to elect to have full display rearview assembly 20 display two or more different views simultaneously.

User interface 72 may allow a user to select which additional views are to be displayed. For example, in FIG. 5C, a full display rearview assembly 20 displays a view behind the vehicle when a trailer is being towed by vehicle. In another example, FIG. 5D illustrates a full display rearview assembly 20 displaying a view behind trailer 48 and the interior of trailer 48. In some embodiments, user interface 72 may enable a user to select to display images on a WIFI-enabled mobile phone. User interface 72 may enable a user to configure full display rearview assembly 20 for their preferred views. User interface 72 may further enable a user to activate additional features of wireless hub system 10 such as, for example, trailer monitoring, rear seat monitoring, and the like.

In some embodiments, wireless hub system 10 may be configured to automatically, upon receipt of a particular user input at user interface 72, cause images captured during a predetermined time interval prior to the receipt of the input to be saved. Wireless hub system 10 may further be configured to save images for a period after the receipt of the particular user input. In some embodiments, video images captured by imager(s) 28A, 28B may be streamed and/or recorded for real-time or subsequent viewing on display or on a user's mobile phone or other device.

As shown in FIG. 6, wireless hub system 10 may be configured to be in communication with a WIFI-enabled mobile phone. Wireless hub system 10 may comprise an application (app) that may be accessed through WIFI-enabled mobile phone. App may comprise a user interface 72 and may allow a user to control functions of wireless hub system 10 through the app. For example, user may be able to select which imagers 28A, 28B have their images displayed on full display rearview assembly 20. User may also be able to view captured images through app on mobile phone. User may further be able to cause wireless hub system 10 to save images through the app.

In some embodiments, WIFI hub 24 may be capable of connecting directly to a WIFI source such as, for example, WIFI at a campground or a rest area. Accordingly, WIFI hub 24 may be capable of storing images in the cloud or on a remote server without going through a WIFI-enabled mobile phone.

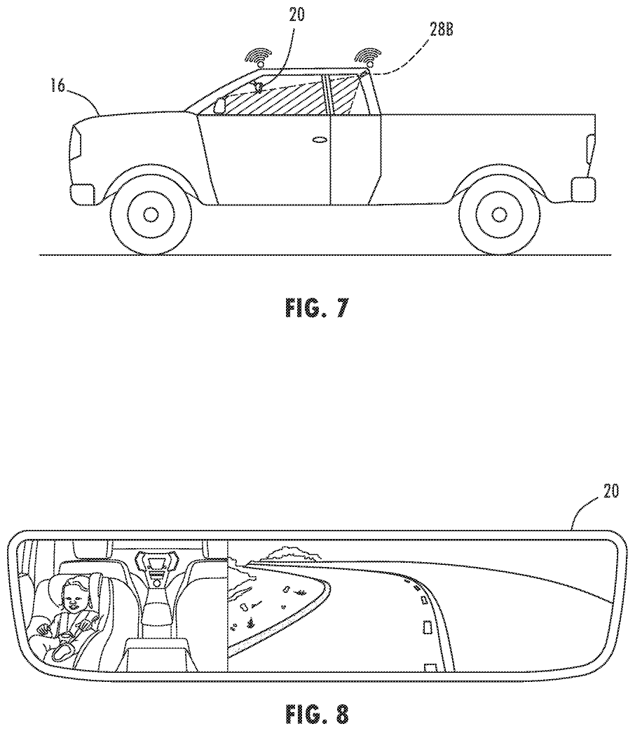

In some embodiments, at least one imager 28A, 28B may be disposed to capture image data from scenes inside vehicle 16. For example, an imager 28A, 28B may be disposed to capture image data of passengers in a rear seat of vehicle 16, as shown in FIG. 7. This may be especially advantageous when children are in rear-facing car seats. Vehicle occupants in the front seat may not be able to see a child in a rear-facing car seat. An imager 28A, 28B positioned to capture image data of rear-seat occupants may allow a front-seat occupant to monitor the rear-facing child while still being able to see the view behind vehicle 16. Continuing the example, imager 28A, 28B may be in communication with full display rearview assembly 20. The images captured by imager 28A, 28B positioned to capture the image data from rear-seat occupants or rear-facing car seats may be displayed on display element 56 adjacent to images of the scene to the rear of vehicle 16 as shown in FIG. 8.

In some embodiments, a plurality of imagers 28A, 28B having different points of view around exterior of vehicle 16 may allow processor 32 to combine captured images to generate a “bird's eye view” of vehicle 16 and/or trailer 48.

In some embodiments, WIFI hub 24 may have its own source of power. In some embodiments, WIFI hub 24 may have or be connected to an external battery 76. External battery 76 may be a battery configured to operate accessories in trailer 48. In some embodiments, the power source may be or may include a vehicle power system. The vehicle power system may include a battery, alternator or generator, power regulating equipment, and/or other electrical power equipment. In further embodiments, the power source may include components such as a battery, capacitor, solar cell, and/or other power generation or storage equipment.

The above description is considered that of the preferred embodiments only. Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the wireless hub system 10 may be varied, the nature or number of adjustment positions provided between the elements may be varied. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

In this document, relational terms, such as first and second, top and bottom, front and back, left and right, vertical, horizontal, and the like, are used solely to distinguish one entity or action from another entity or action, without necessarily requiring or implying any actual such relationship, order, or number of such entities or actions. These terms are not meant to limit the element which they describe, as the various elements may be oriented differently in various applications. Furthermore, it is to be understood that the device may assume various orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It will be understood that any described processes or steps within described processes may be combined with other disclosed processes or steps to form structures within the scope of the present disclosure. The exemplary processes disclosed herein are for illustrative purposes and are not to be construed as limiting. It is also to be understood that variations and modifications can be made on the aforementioned methods without departing from the concepts of the present disclosure, and further it is to be understood that such concepts are intended to be covered by the following claims unless these claims by their language expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within at least one of 2% of each other, 5% of each other, and 10% of each other.

1. A system, comprising:
a rearview assembly comprising a display element and having WIFI capability;
a WIFI hub removably securable to a surface, the WIFI hub having the capability to transmit and receive signals via WIFI, the WIFI hub comprising at least one imager capable of capturing images of a scene;
an image processor in communication with the rearview assembly, the image processor being capable of processing captured images;
wherein the WIFI hub is capable of transmitting image data from the captured images to the rearview assembly; and
wherein the rearview assembly is capable of displaying images from the image data from the captured images.

2. The system of claim 1, further comprising at least one second imager in communication with the WIFI hub;
wherein the WIFI hub is capable of receiving and transmitting image data from a plurality of imagers; and
wherein the second imager is located remotely from the WIFI hub.

3. The system of claim 2, wherein at least one of the imagers comprises an infrared light source and is configured to capture images using infrared light.

4. The system of claim 2, wherein the at least one second imager is removably securable to a surface.

5. The system of claim 1, wherein the WIFI hub is capable of communicating with external devices through signals transmitted through WIFI.

6. The system of claim 1, wherein the image processor is in communication with the rearview assembly; and
wherein the rearview assembly displays the captured images on the display element.

7. The system of claim 1, further comprising a memory, wherein a subset of captured images may be stored in the memory.

8. The system of claim 2, further comprising a user interface;
wherein the user interface allows a user to cause the display of two different images on the display element of the rearview assembly and wherein one of the displayed images comprises images captured by the one of the imager of the WIFI hub and the second imager.

9. The system of claim 8, further comprising a user interface;
wherein the user interface allows a user to activate one or more of the at least one second imagers.

10. The system of claim 1, wherein the system further comprises an application that is accessible through a mobile phone.

11. The system of claim 1, wherein the system is capable of connecting directly to a WIFI source.

12. The system of claim 11, wherein the system is capable of wirelessly storing images on a remote server.

13. The system of claim 2, wherein at least one of the second imagers is positioned to capture image data from inside the vehicle.

14. The system of claim 1, wherein the WIFI hub comprises its own source of power.
